(19) United States
(12) Patent Application Publication
(10) Pub. No.: US 2008/0196528 A1
(43) Pub. Date: Aug. 21, 2008

(54) Internal Circulation Ball Screw

(76) Inventors: Yu-Shan Lee, Taichung Industrial Park (TW); Yuen-Ling Chiu, Taichung Industrial Park (TW)

Correspondence Address: Dr. BANGER SHIA, 102 Lindencrest Ct., Sugar Land, TX, 77479-5201, US

(21) Appl. No.: 11/676,274

(22) Filed: Feb. 17, 2007

(51) Int. Cl. F16H 25/22

(52) U.S. Cl. 74/424.86

(57) ABSTRACT

An internal circulation ball screw comprises a nut, a screw, a plurality of return assemblies, and a plurality of balls. The nut is threaded on the screw through the balls. An arc-shaped curving surface is formed on the edge of a tip of an outer thread of the screw and is to be connected to a return path of the return assemblies. The radius of the arc-shaped curving surface of the screw is between 9%-17% of the diameter of a ball, and each of the outer threads of the screw has three different curvature sections formed at the positions where the balls climb over, which are climbing curvature section, fillet curvature section and tip curvature section. By such arrangements, the internal circulation ball screw can allow the balls to move more smoothly and stably, and keep the balls from falling off or deflecting.

### BACKGROUND OF THE INVENTION

1. Field of the Invention

The present invention relates to a ball screw, and more particularly to an internal circulation ball screw, which can make the return path for balls smoother and keep the balls from falling off or deflecting, therefore allowing the balls to move more smoothly and stably.

2. Description of the Prior Art

Nowadays, ball screws are applied in the industry more and more, besides the high precision effect for the linear feed transmission, it further has the advantages of low frictional loss ratio, high energy-conversion ratio, low noise, and high stiffness, less likely to be damaged, etc. Hence, it is self-evident that the ball screw is very important to the recent various industrial mechanisms.

In order to enable the balls between the nut and the screw to circulate endlessly, the existing linear guideway is usually provided with a plurality of return assemblies for enabling the balls to climb over the tip of the thread of the screw and then return to its internal circulation. However, different designs all have their respective shortcomings, accordingly, the recent industry emphasis is focused on how to research and develop a more competitive internal ball screw.

Frequently used conventional internal circulation ball screws are shown in FIGS. 1-2.

FIG. 1 is a cross sectional view of the internal circulation ball screw of U.S. Pat. No. 2,618,166. Balls 10 circulate within a return path 13 defined between a screw 11 and a plurality of return assemblies 12, and the return path 13 is connected to two abutting threads 14 of the screw 11, so that the balls 10 climb over the tip 15 of one thread and then roll into another abutting thread 14 through the return path 13 to achieve endless circulation. But the abovementioned conventional technique will bring about the following problems:

Firstly, an edge of the tip 15 of the screw 11 is an inconsecutive sharp angle, so when the balls 10 are passing through the tip 15 at a high speed, they are likely to impact the edge of the tip 15 violently.

Secondly, because of the inconsecutive sharp angle at the edge of the tip 15 of the screw 11, when the return path 13 is not appropriately processed, the balls 10 are likely to be blocked or crush each other, so that each relative assemblies will be damaged, thus reducing the service life of the product.

In order to solve the abovementioned problems, another internal circulation ball screw appeared in the market, as shown in FIG. 2, another U.S. Pat. No. 7,013,747. A tip 17 of a screw 16 is approximately semicircle-shaped to allow the balls 18 to climb over the tip 17 of the screw 16 through a return path 19 smoothly and quickly. It seems that this improved technique of the ball screw solved the abovementioned problems, but it will bring about new problems in practical use.

Firstly, the tips 17 of the whole screw 16 should be made into a semicircle-shape, which is a great difficulty.

Secondly, because the tips 17 of the whole screw 16 should be made into a semicircle-shape, a relatively large gap will be produced at any position of the tips 17 whether the balls climb or not. Although being restricted by the tips of a nut, the balls 18 will not impact the right and left side, the semicircle-shaped tips 17 of the screw 16 will produce a gap between the screw 16 and the balls 18. Therefore, the screw 16 is likely to shake and unstable during movement, causing more severe problems.

The present invention has arisen to mitigate and/or obviate the afore-described disadvantages.

### SUMMARY OF THE INVENTION

The primary objective of the present invention is to provide an internal circulation ball screw that allows the balls to move more smoothly and stably.

The secondary objective of the present invention is to provide an internal circulation ball screw that is easily made with low cost.

In order to achieve the abovementioned objectives, an arc-shaped curving surface is formed on the edge of a tip of an outer thread of a screw of the present invention, and experiments prove that the radius of curvature of the arc-shaped curving surface of the screw is preferably between 9%-17% of the diameter of a ball. Each of the outer threads of the screw has three different curvature sections formed at the positions where the balls climb over, which are climbing curvature section, fillet curvature section and tip curvature section. The climbing curvature section of the outer threads of the screw refers to the curvature of the profile of the outer threads of the screw. The fillet curvature section of the outer threads of the screw refers to the curvature of the edge of the outer threads of the screw. The tip curvature section of the outer threads of the screw refers to the curvature of the top of the outer threads of the screw.

By such arrangements, the outer threads of the whole screw of the present invention will not produce a large gap, so that the instability caused by the semicircle-shaped tips of the conventional screw can be avoided. The cooperation of the fillet curvature section with a smaller curvature and the tip curvature section with a greater curvature can not only enable the balls to climb the threads easily, but also provide the necessary torque force and stability during the circulation of the balls.

The experiments prove that an arc-shaped curving surface should be formed on the edge of a tip of an outer thread of the screw and the radius of curvature of the arc-shaped curving surface of the screw is preferably between 9%-17% of the diameter of a ball, for the ball screw will produce a better loading capacity.

### BRIEF DESCRIPTION OF THE DRAWINGS

FIG. 1 is a cross sectional view of a part of a conventional ball screw of U.S. Pat. No. 2,618,166;

FIG. 2 is an enlarged cross sectional view of a part of a conventional ball screw U.S. Pat. No. 7,013,747;

FIG. 3 is a perspective view of a ball screw in accordance with the present invention;

FIG. 4 is a cross sectional view of a thread of the ball screw in accordance with the present invention;

FIG. 5 is an enlarged cross sectional view of the a thread of the ball screw in accordance with the present invention;

FIG. 6 is a torque force comparison diagram between the present invention and a conventional product without a second fillet curvature; and

FIG. 7 is a data diagram of showing the necessary torque force associated with different fillet curvatures, under the condition that the ball diameter is 4.763 mm and 6.35.

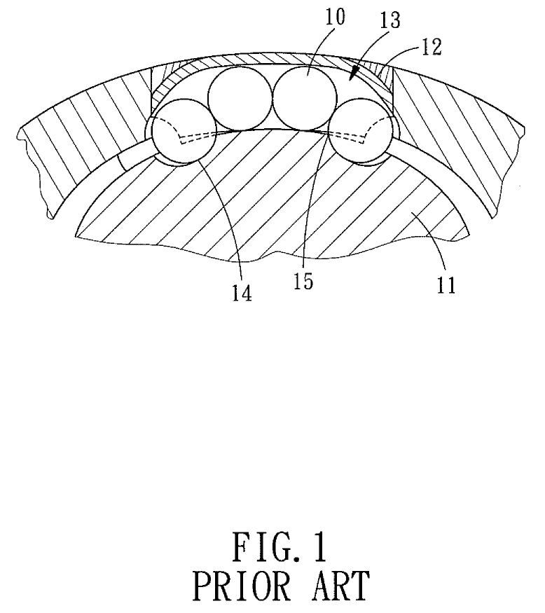

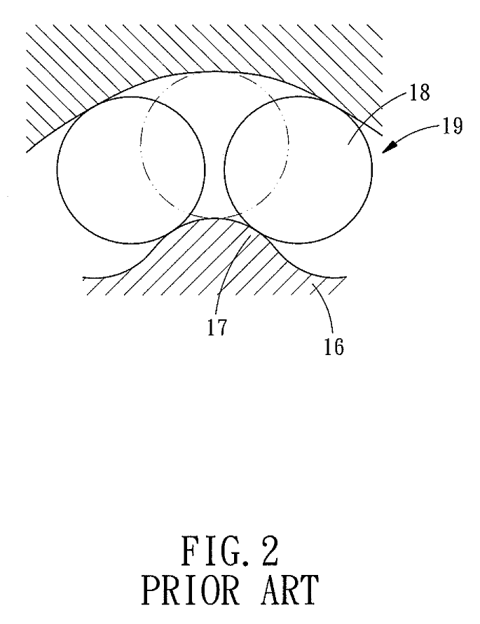

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

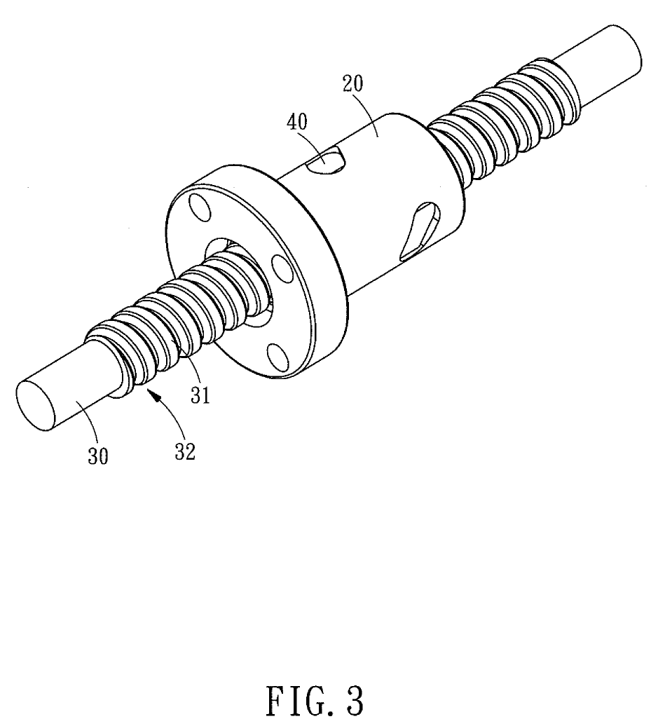

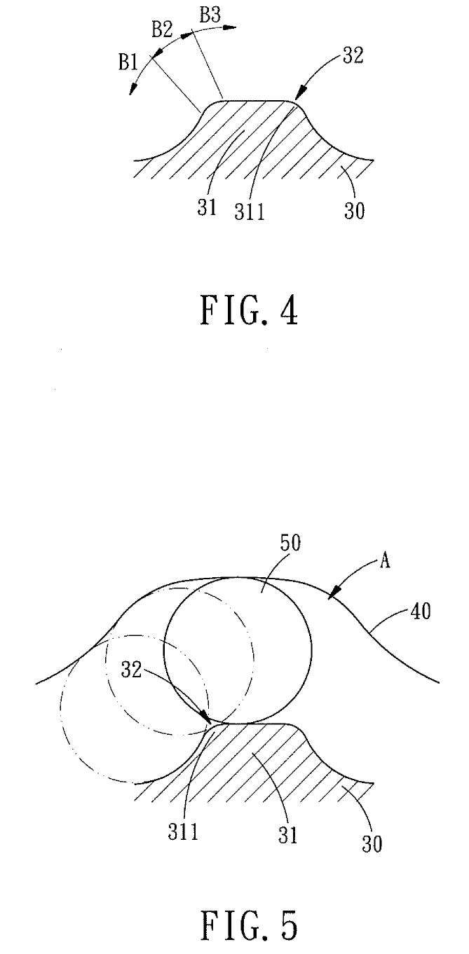

Referring to FIGS. 3-5, an internal circulation ball screw in accordance with the present invention comprises a nut 20, a screw 30, a plurality of return assemblies 40, and a plurality of balls 50. The nut 20 is threaded on the screw 30 through the balls 50. The present invention is characterized in that:

An arc-shaped curving surface 32 is formed on the edge of a tip 311 of an outer thread 31 of the screw 30 and is to be connected to a return path A of the return assemblies 40. The radius of the arc-shaped curving surface 32 of the screw 30 is between 9%-17% of the diameter of a ball 50.

Each of the outer threads 31 of the screw 30 has three different curvature sections formed at the positions where the balls 50 climb over, which are climbing curvature section B1, fillet curvature section B2 and tip curvature section B3.

The climbing curvature section B1 of the outer threads 31 of the screw 30 refers to the curvature of the profile of the outer threads 31 of the screw 30.

The fillet curvature section B2 of the outer threads 31 of the screw 30 refers to the curvature of the edge of the outer threads 31 of the screw 30.

The tip curvature section B3 of the outer threads 31 of the screw 30 refers to the curvature of the top of the outer threads 31 of the screw 30.

Abovementioned is an illustration of the location and the structure of the respectively related subassemblies of the present invention.

It is noted that each of the outer threads 31 of the screw 30 has three different curvature sections formed at the positions where the balls 50 climb over, which are climbing curvature section B1, fillet curvature section B2 and tip curvature section B3. When the balls 50 climb over the tip of the threads, the fillet curvature section B2 enables the balls 50 to move more smoothly and avoid impacting and being blocked, and with the cooperation of the climbing curvature section B1, the fillet curvature section B2 and the tip curvature section B3, the outer threads 31 of the whole screw 30 of the present invention will not produce a large gap, so that the instability caused by the semicircle-shaped tips of the conventional screw can be avoided. The cooperation of the climbing curvature section B1, the fillet curvature section B2 and the tip curvature section B3 can not only enable the balls 50 to climb the threads easily, but also provide the necessary torque force and stability during the circulation of the balls 50.

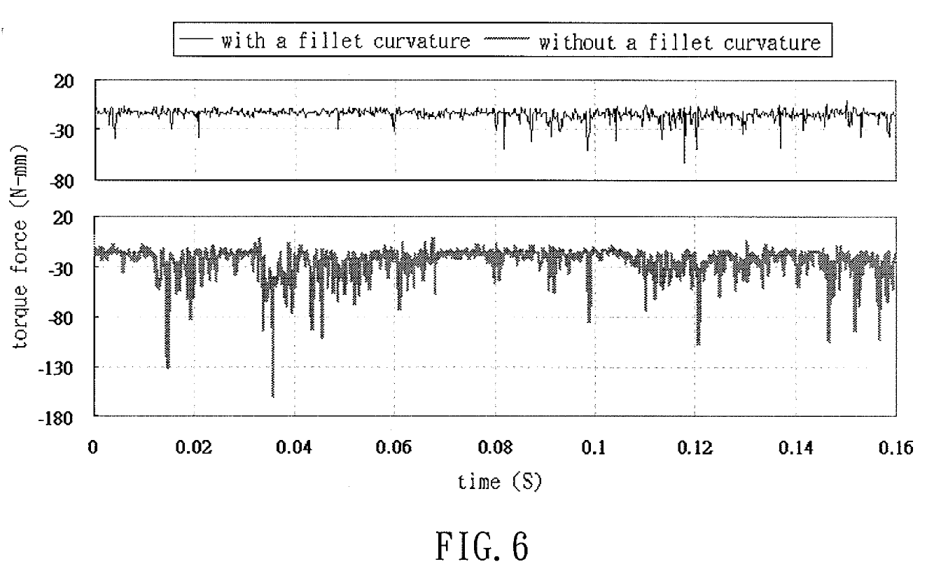

Referring to FIG. 6, which is a torque force comparison diagram between the present invention and a conventional product without a second fillet curvature (dark color and light color indicate the data line of the screws with and without a second fillet curvature, respectively). The resultant value of the torque force N-mm generated at the same time S shows that, the torque force of the screw without a second fillet curvature is unstable, and its average torque force is relatively great as compared with a screw with a second fillet curvature. The torque force of the screw 30 with the fillet curvature section B2 in accordance with the present invention is comparatively stable.

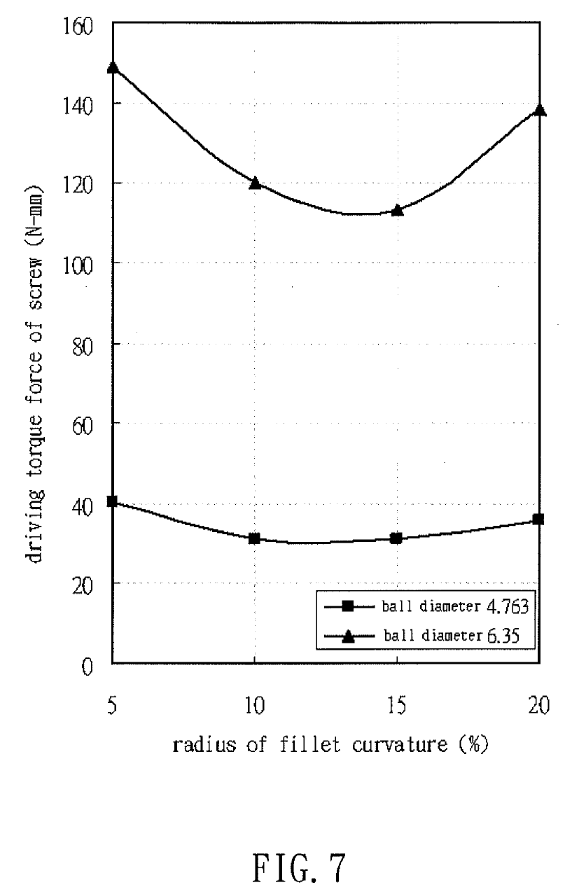

Referring to FIG. 7, which is a data diagram of showing the necessary driving torque force associated with different fillet curvatures %, under the condition that the ball diameter is 4.763 mm and 6.35. The experiments prove that the radius of curvature of the arc-shaped curving surface of the screw is preferably between 9%-17% of the diameter of a ball, and accordingly the range of curvature of the fillet curvature section B2 is defined.

To sum up, the present invention comprises a nut, a screw, a plurality of return assemblies, and a plurality of balls. The nut is threaded on the screw through the balls. An arc-shaped curving surface is formed on the edge of a tip of an outer thread of the screw and is to be connected to a return path of the return assemblies. The radius of the arc-shaped curving surface of the screw is between 9%-17% of the diameter of a ball, and each of the outer threads of the screw has three different curvature sections formed at the positions where the balls climb over, which are climbing curvature section, fillet curvature section and tip curvature section. By such arrangements, the arc-shaped curving surface can allow the balls to move smoothly and more stably.

While we have shown and described various embodiments in accordance with the present invention, it is clear to those skilled in the art that further embodiments may be made without departing from the scope of the present invention.

What is claimed is:

1. An internal circulation ball screw comprising:
a screw having outer threads, a nut, a plurality of return assemblies, and a plurality of balls, the nut being threaded on the screw through the balls and the return assemblies being fixed on the nut, characterized in that:
an arc-shaped curving surface is formed on an edge of a tip of an outer thread of the screw and is to be connected to a return path of the return assemblies.

2. The internal circulation ball screw as claimed in claim 1, wherein a radius of the arc-shaped curving surface of the screw is between 9%-17% of a diameter of a ball.

3. The internal circulation ball screw as claimed in claim 1, wherein each of the outer threads of the screw has three different curvature sections formed at the positions where the balls climb over, which are climbing curvature section, fillet curvature section and tip curvature section.

4. The internal circulation ball screw as claimed in claim 3, wherein the climbing curvature section of the outer threads of the screw refers to the curvature of a profile of the outer threads of the screw.

5. The internal circulation ball screw as claimed in claim 3, wherein the fillet curvature section of the outer threads of the screw refers to the curvature of an edge of the outer threads of the screw.

6. The internal circulation ball screw as claimed in claim 3, wherein the tip curvature section of the outer threads of the screw refers to the curvature of a top of the outer threads of the screw.
